(19) United States
(12) Patent Application Publication
(10) Pub. No.: US 2014/0032757 A1
(43) Pub. Date: Jan. 30, 2014

(54) METHOD FOR ADAPTIVE APPLICATION BEHAVIOR BASED ON CELLULAR NETWORK STATISTICS

(71) Applicants: Rickard Ljung, Helsingborg (SE); Linh Trang, Akarp (SE)

(72) Inventors: Rickard Ljung, Helsingborg (SE); Linh Trang, Akarp (SE)

(73) Assignee: SONY MOBILE COMMUNICATIONS AB, Lund (SE)

(21) Appl. No.: 13/923,796

(22) Filed: Jun. 21, 2013

Related U.S. Application Data
(60) Provisional application No. 61/675,982, filed on Jul. 26, 2012.

(51) Int. Cl. H04L 12/24

(52) U.S. Cl. CPC H04L 41/00
USPC 709/225

(57) ABSTRACT

A method for controlling the access of at least one application, in an application entity, to at least one modem, in a modem entity, where the controlling is performed using a modem access information framework. The modem access information framework collects modem access information from the modem access interface based on activity of the at least one modem, and distributes the modem access information to any of the at least one application that is subscribing to the modem access information or requesting the modem access information from the modem access information framework.

### RELATED APPLICATIONS

This application claims priority under 35 U.S.C. §119 based on U.S. Provisional Patent Application No. 61/675,982 filed Jul. 26, 2012, and Patent Cooperation Treaty (PCT) Application No. PCT/EP2012/068258, filed Jul. 26, 2012, the disclosures of which are both hereby incorporated by reference herein.

### TECHNICAL FIELD

The present invention relates to the field of mobile communication devices and, in particular, to the modem utilization in such devices.

### BACKGROUND

A terminal in cellular mobile communication systems can typically be divided into two entities: an application entity and a modem entity.

The application entity controls any end-user interactions such as information transmitted to and from the display, the keyboard etc., and it also handles the programs or applications processing information within the application entity. The application entity is connected to the modem entity, wherein the modem entity consists of one or more modems for communication with mobile communication networks or other mobile communication devices.

The modem entity is controlled by the application entity. For example, for terminal originating transmissions, the application entity controls when the modem shall initiate communication with the network, e.g., to start a voice call or to transfer data over a mobile communication network. Within the application entity, an operating system is running, handling all programs/applications that are executed on the terminal. Applications can, for example, be launched to display and handle calendar, alarm clock, weather information, Internet browsing, social networking, games, etc. Multiple programs/applications can typically be running at the same time within the operating system, even in so-called background mode, meaning that they are updating its information regularly also when the display is showing another program or when the terminal is not used by the end user and therefore is in standby mode.

Each program/application has, via the operating system, a possibility to utilize the modem entity for voice/data communications. Since each program within the application entity can request modem connectivity via the operating system, and several applications are typically running at the same time, it may result in multiple uncoordinated requests to utilize modem connectivity. Each requested modem activity will activate the modem, and the utilization of the modem connectivity will consume additional battery consumption as compared to if the modem is in standby mode.

Also, within a mobile communication system the network access possibilities for a modem will be different over time, depending on several parameters. Examples of parameters influencing network access behavior are e.g., terminal mobility, properties of the utilized mobile network technology, terminal-to-base station distance and current network load. In case of a highly loaded and thereby a congested network, a new additional modem access request will further load the network and the network will not be able to expedite the currently active modem requests efficiently. In case of a terminal being close to the edge of a cell, the required output power will be high both in terminal side and network base station side, consuming a high amount of battery current in the terminal and high amount to total capacity in the base station.

Thus, finding a way to control the modem access to avoid unnecessary modem requests and thereby reduce power consumption and congestion of the modem would be highly sought after.

### SUMMARY OF THE INVENTION

With the above description in mind, an aspect of the present invention is to provide a framework for controlling and optimizing the modem access in a mobile communication device which seeks to mitigate, alleviate, or eliminate one or more of the above-identified deficiencies in the art and disadvantages singularly or in any combination.

By introducing a modem access information framework for communicating with the modem entity, it is possible to distribute information which allows the applications to dynamically adapt their modem access request behavior, reducing impact of congested networks and increasing terminal battery life.

A first aspect of the present invention relates to a method for controlling the access of at least one application, in an application entity, to at least one modem, in a modem entity, characterized in that said controlling is performed using a modem access information framework, wherein said modem access information framework is collecting modem access information from a modem access interface based on activity of said at least one modem, and distributing said modem access information to any of said at least one application which is subscribing to said modem access information or requesting said modem access information from said modem access information framework.

The method wherein said distribution may be performed periodically if subscribed to.

The method wherein said modem access information may comprise at least one network performance indicator (NPI), collected by said modem access interface from said modem entity.

The method wherein said at least one NPI may be any of: information on average network access latency, block error rate, average transmit rate, receive data rate and received signal-to-noise ratio.

The method wherein said at least one application may subscribe to at least one of said at least one NPI.

The method wherein said at least one application may adjust its modem requests based on said modem access information.

The method wherein said at least one application may schedule when to send a modem request based on said modem access information.

The method wherein said modem access information may further comprise a modem usage pattern compiled by said modem access information frame work based on one or more of said at least one NPI.

The method wherein said at least one application may adjust its modem requests based on said modem usage pattern in said modem access information.

The method may be used in a mobile communication device and said mobile communication device may use the modem access information to notify a base station network about a suitable discontinuous transmission/reception (DRX/DTX) pattern.

A second aspect of the present invention relates to a mobile communication device comprising an application entity with at least one application, a modem access interface, and a modem entity, connected to said modem access interface, with at least one modem for cellular network access, characterized in that said application entity comprises a modem access information framework connected to said at least one application and to said modem access interface, wherein said mobile communication device is adapted to perform the method as described above.

Any of the features in the first aspect of the present invention above may be combined, in any way possible, as to form different embodiments of the present invention.

### BRIEF DESCRIPTION OF THE DRAWINGS

Further aspects, features, and advantages of the present invention will appear from the following detailed description of some embodiments and variants of the invention, wherein some embodiments or variants of the invention will be described in more detail with reference to the accompanying drawings, in which:

FIG. 1 shows a block diagram of a communication framework, according to prior art; and

FIG. 2 shows a block diagram of a communication framework, according to an embodiment of the present invention.

### DETAILED DESCRIPTION

Embodiments of the present invention will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference signs refer to like elements throughout the description.

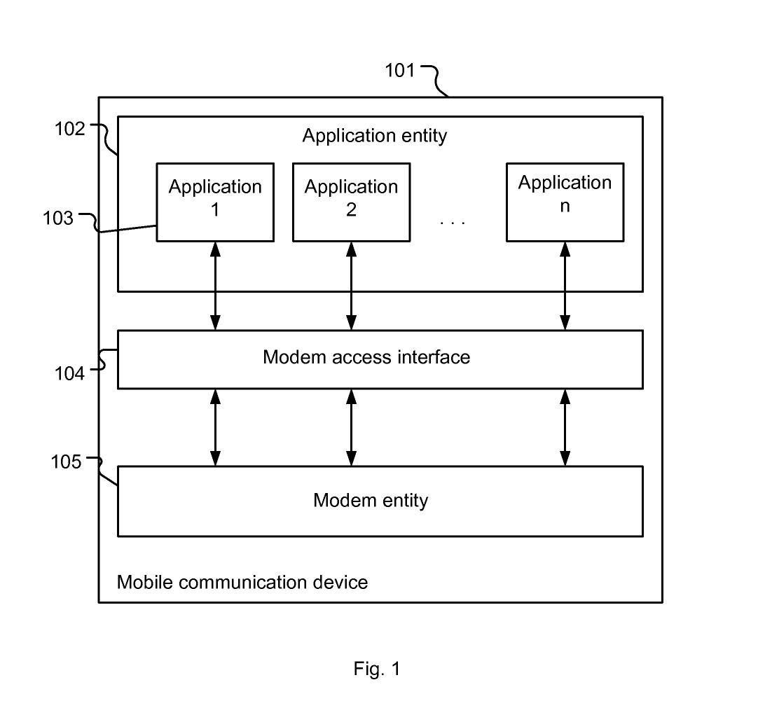

FIG. 1 illustrates applications 103, in an application entity 102, running in a mobile communication device 101 individually utilizing one (or several) modems in a modem entity 105 for cellular network access via an modem access interface 104 within an operating system, as described in the background section.

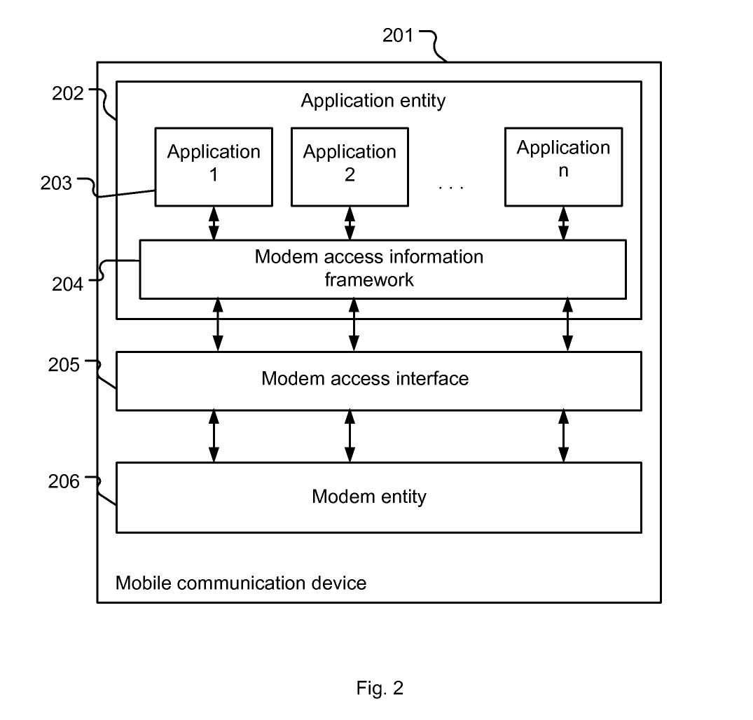

The present invention, as illustrated in FIG. 2, imposes a modem access information framework 204 for applications/programs 203 within the operating system of the application entity 202. The modem access information framework 204 collects modem access information from either the applications 203 (or the application entity 202), the modem access interface 205 or the modem entity 206. The modem access information framework 204 also distributes and makes available the modem access information to running applications 203 in the mobile communication device 201 that requests such information. The request for modem access information is initially made from the applications 203 to the modem access information framework 204. The current modem access information can thereafter either periodically be distributed to running applications that have subscribed to the modem access information, or individually as requested by each application 203.

The principle of the modem access information framework 204 is that the applications 203 initially individually requests modem access and the data to and from the modem(s) in the modem entity 206 is individually signalled, but during modem activity, modem network access information is sent from modem access interface 205 to the modem access information framework 204. This means that during modem activity the modem access interface 205 sends a set of different network performance indicators (NPIs) or at least one NPI. The NPIs are based on information received from the modem entity 206. The NPIs are defined within the modem access interface 205 to give guidance to applications 203 on the current modem network access properties or status.

NPIs may include but are not limited to information on average network access latency, block error rate, average transmit and receive data rate and received signal-to-noise ratio. The NPI may comprise any kind of modem related access status information. Each application 203 can subscribe to regularly receive one or more of these NPIs from the modem access information framework. Hence, the NPI statistics are collected within the modem access information framework 204. The NPI statistics are distributed to running applications that have subscribed to one or more NPIs. During this transmission, NPIs are collected by the modem access interface from said modem entity, and sent to or collected by the modem access information framework 204, which distributes it to subscribing applications, such as 203 “1” and 203 “2” in FIG. 2. Then, for example, 203 “1” can, based on the modem access information containing one or more NPIs, dynamically adjust its ongoing modem requests, and 203 “2” can schedule when to utilize the modem or when to send a modem request, based on the modem access information comprising one or more NPIs.

The main benefit with the proposed framework in the present invention is that applications using the modem(s) will be informed about the current network status/properties of its own choice, and can adaptively adjust its modem access requests based on this information. As an example, an application with an ongoing streaming service can subscribe for data rate and delay NPIs and thereafter adjust its streaming data rate to current network data rate or network delay statistics. Also an application which periodically requests modem access for status updates can for instance subscribe to signal-to-noise NPIs and modify the period between update requests based on current network signal-to-noise ratio statistics.

This will both make it possible to reduce impact of network congestion in a network operator perspective, and also allow a service to continue to run in a slower network if e.g., a streaming service reduces the quality (i.e., required application data rate) of the streaming service. Also terminals in cell edge scenarios can reduce modem activities in order to save terminal battery lifetime.

FIG. 2 shows a number of active applications 203, 1 to n, running within the application entity 202. These applications 203 are running within the operating system, and each of the applications 203 have direct control via specified protocol to request modem access, e.g., data transmissions and receptions, message transmissions and voice calls. With the proposed modem access control framework 204 as a controlling interface between applications 203 and the modem(s) in the modem entity 206, a policy for handling of modem requests is presented. Each application can, within the framework, specify its request for modem access permissions via modem requests. The framework defines separate access control for different modes of terminal operation, i.e., whether the application is running in active mode or in standby mode. The framework also gives the application possibility to, within its modem requests, specify the modem access needed for each mode. Once an application 203 has specified its modem request, the modem access information framework 204 within the operating system of the application entity 202 responds with a modem request response. Within this response the control modem access information framework can send a modem usage pattern describing when the application(s) 203 is allowed to use the modem(s) in the modem entity 206. Either this is fully according to the application's 203 request, or it is a modified pattern based on policy control within the modem entity. The modem usage pattern is compiled in the modem access information framework and may be based on one or more of said at least one NPIs.

Hence, after receiving a modem request response, the application 203 has received information about when it is allowed to utilize the modem(s) in the modem entity 206. Each application running will therefore know when it is allowed to access the modem, and the operating system will have the combined control and knowledge of the total modem utilization pattern. It can be noted that this combined modem usage information could potentially be used by the terminal to notify the base station network about a suitable discontinuous transmission/reception (DRX/DTX) pattern, in order to maximize the benefits of DRX/DTX.

The agreed modem access usage pattern is then followed by each application 203 either until the application is terminated, or until it requests a change in the modem utilization by means of a modem request update. The modem access information framework responds to these requests with a termination acknowledgement or a modem request update response, respectively. A major benefit from the present invention is reached at terminal standby operation, where applications may indicate their requests for background synchronizations. These background activities may consist of applications, even in non-active mode, updating calendar, email account, weather status, social networking activities, etc. With all these requests uncoordinated, this would lead to significant modem activity within terminal standby mode. However, with the modem access information framework, all background activities can be synchronized, and, via the operating system, also limited to a certain amount of total background updates per hour. Hence, there is possibility to significantly reduce modem usage during terminal standby operation. All in all, the present invention will enable operating systems to fully control modem utilization, to reduce modem usage cycles, e.g., in standby mode, and therefore improve battery life. In addition, aspects described herein enable operating systems within a terminal to be fully aware of modem utilization patterns, e.g., to enable a known modem usage pattern to be translated into a proposal for optimal DRX/DTX settings for the terminal, if signalling of such suggestion would be possible.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

The foregoing has described the principles, preferred embodiments and modes of operation of the present invention. However, the invention should be regarded as illustrative rather than restrictive, and not as being limited to the particular embodiments discussed above. The different features of the various embodiments of the invention can be combined in other combinations than those explicitly described. It should therefore be appreciated that variations may be made in those embodiments by those skilled in the art without departing from the scope of the present invention as defined by the following claims.

1. A method for controlling the access of at least one application in an application entity to at least one modem, in a modem entity, comprising:
controlling the access to the at least one modem using a modem access information framework, wherein said modem access information framework collects modem access information from a modem access interface based on activity of said at least one modem; and
distributing said modem access information to any of said at least one application that is subscribing to said modem access information or requesting said modem access information from said modem access information framework.

2. The method according to claim 1, wherein said distributing is performed periodically for a subscribing application.

3. The method according to claim 1, wherein said modem access information comprises at least one network performance indicator (NPI), collected by said modem access interface from said modem entity.

4. The method according to claim 3, wherein said at least one NPI comprises any of: information on average network access latency, block error rate, average transmit rate, receive data rate or received signal-to-noise ratio.

5. The method according to claim 4, wherein said at least one application subscribes to at least one of said at least one NPI.

6. The method according to claim 1, wherein said at least one application adjusts its modem requests based on said modem access information.

7. The method according to claim 1, wherein said at least one application schedules when to send a modem request based on said modem access information.

8. The method according to claim 3, wherein said modem access information further comprises a modem usage pattern compiled by said modem access information framework based on one or more of said at least one NPI.

9. The method according to claim 8, wherein said at least one application adjusts its modem requests based on said modem usage pattern in said modem access information.

10. The method according to claim 1, wherein the method is used in a mobile communication device and wherein said mobile communication device uses the modem access information to notify a base station network about a suitable discontinuous transmission/reception (DRX/DTX) pattern.

11. A mobile communication device comprising:
an application entity with at least one application,
a modem access interface, and
a modem entity connected to said modem access interface, with at least one modem for cellular network access,
wherein said application entity comprises a modem access information framework connected to said at least one application and to said modem access interface, wherein said mobile communication device is configured to perform the method of claim 1.
